(19) United States
(12) Patent Application Publication
(10) Pub. No.: US 2017/0272995 A1
(43) Pub. Date: Sep. 21, 2017

(54) METHOD AND APPARATUS FOR PROVIDING SMART NETWORK CONNECTION MANAGEMENT

(71) Applicant: Samsung Electronics Co., Ltd., Gyeonggi-do (KR)

(72) Inventors: Hye Jeong KIM, Gyeonggi-do (KR); Jung Hoon Ahn, Seoul (KR); Sang Hoon Kim, Gyeonggi-do (KR); Han Sung Leem, Gyeonggi-do (KR); Ju Hee Jang, Gyeonggi-do (KR)

(73) Assignee: Samsung Electronics Co., Ltd.

(21) Appl. No.: 15/464,872

(22) Filed: Mar. 21, 2017

(30) Foreign Application Priority Data
Mar. 21, 2016 (KR) 10-2016-0033669

(51) Int. Cl. H04W 36/22; H04L 12/26; H04W 36/30; H04M 15/18; H04M 15/16; H04W 36/14; H04L 29/06; H04W 48/18

(52) U.S. Cl. CPC H04W 36/22; H04L 65/80; H04L 43/0888; H04W 48/18; H04M 15/18; H04M 15/16; H04W 36/14; H04W 36/30; H04W 84/12

(57) ABSTRACT

A mobile device is provided. The mobile device includes a memory configured to store a plurality of applications, a communication circuit including a first communication module and a second communication module, and a processor electrically connected with the communication circuit. The processor is configured to execute an application among the plurality of applications, determine a communication state of the first network and a communication state of the second network in response to executing the application, select one of the first network and the second network based on the communication state of the first network, the communication state of the second network, a tariff applied to the mobile device, a service policy applied to the application, performance criteria applied to the application, and network selection criteria, and download data from a server associated with the application using the selected network.

### PRIORITY

This application claims priority under 35 U.S.C. §119(a) to Korean Patent Application Serial No. 10-2016-0033669, which was filed on Mar. 21, 2016 in the Korean Intellectual Property Office, the entire disclosure of which is incorporated herein by reference.

### BACKGROUND

### 1. Field of the Disclosure

The present disclosure generally relates to a method and apparatus, and more particularly, to a method and apparatus for selectively using a network in an electronic device.

### 2. Description of the Related Art

A mobile device, such as a smartphone, supports a cellular network such as third generation (3G) or long term evolution (LTE). In addition, wireless communication technology such as wireless-fidelity (Wi-Fi), which complies with a specific data transfer protocol (e.g., the institute of electrical and electronics engineers (IEEE) 802.11), may be supported by mobile terminals. In addition, wireless communication technology such as Bluetooth, which complies with IEEE 802.15.1, may be supported by mobile terminals.

The various wireless communication technologies may provide different data throughputs based on frequency bands, modulation techniques, or other technology features. Data throughput may be limited based on the number of mobile terminals (referred to as “user equipment (UE)”) connected to a network or an access point (AP).

As cellular network technologies have developed and data usage charges reduced by service providers or mobile network operators (MNOs), there is a trend for many users to download data using a cellular network which ensures broader coverage, a stable speed and a stable connection state. Thus, data traffic may be congested on the cellular network. Data offloading technologies, such as a multi path transmission control protocol (MPTCP), an access network discovery and selection function (ANDSF), a multiple access PDN connectivity (MAPCON) and an Internet protocol (IP) flow mobility (IFOM), have been developed to address network coverage and capacity. However, the above-mentioned technologies may require a proxy server or a policy server, thus increasing costs to service providers or MNOs.

### SUMMARY

Aspects of the present disclosure are to address at least the above-mentioned problems and/or disadvantages and to provide at least the advantages described below. Accordingly, an aspect of the present disclosure provides a method of facilitating data offloading in a mobile terminal without establishing a separate server and providing an enhanced user experience (UX) to a user.

In accordance with an aspect of the present disclosure, a mobile device is provided. The mobile device includes a memory configured to store a plurality of applications, a communication circuit including a first communication module and a second communication module, the first communication module being connected to a first network using a first communication protocol and the second communication module being connected to a second network using a second communication protocol, and a processor electrically connected with the communication circuit. The processor is configured to execute a streaming service application among the plurality of applications, determine a communication state of the first network and a communication state of the second network in response to executing the streaming service application, select one of the first network and the second network based on the communication state of the first network, the communication state of the second network, and a tariff applied to the mobile device, and download content associated with the streaming service application from a streaming server using the selected network.

In accordance with another aspect of the present disclosure, a mobile device is provided. The mobile device includes a memory configured to store a plurality of applications, a communication circuit including a first communication module and a second communication module, and a processor electrically connected with the communication circuit. The processor is configured to execute an application among the plurality of applications, determine a communication state of the first network and a communication state of the second network in response to executing the application, select one of the first network and the second network based on the communication state of the first network, the communication state of the second network, a tariff applied to the mobile device, a service policy applied to the application, performance criteria applied to the application, and network selection criteria, and download data from a server associated with the application using the selected network.

In accordance with another aspect of the present disclosure, a network connection management method of a mobile device is provided. The method includes executing a streaming service application, determining a communication state of a first network and a communication state of a second network in response to executing the streaming service application, selecting one of the first network and the second network based on the communication state of the first network, the communication state of the second network and a tariff applied to the mobile device, and downloading content associated with the streaming service application from a streaming server using the selected network.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of a mobile device, according to an embodiment of the present disclosure;

FIG. 2 is a block diagram illustrating a connectivity manager for smart connection management (CM), according to an embodiment of the present disclosure;

FIG. 3 illustrates an enhanced network selection algorithm, according to an embodiment of the present disclosure;

FIG. 4 is a flowchart illustrating an operation of switching a connection from a wireless-fidelity (Wi-Fi) network to a cellular network, according to an embodiment of the present disclosure;

FIG. 5 is a flowchart illustrating an operation of switching a connection from a cellular network to a Wi-Fi network, according to an embodiment of the present disclosure;

FIG. 6 is a flowchart illustrating a smart CM process, according to an embodiment of the present disclosure;

FIG. 7 is a flowchart illustrating an initial procedure, according to an embodiment of the present disclosure;

FIG. 8 is a flowchart illustrating a network CM process, according to an embodiment of the present disclosure;

FIG. 9 illustrates a user interface (UI) for setting smart CM, according to an embodiment of the present disclosure; and

FIG. 10 illustrates a UI for selecting smart CM, according to an embodiment of the present disclosure.

### DETAILED DESCRIPTION

Throughout the drawings, it should be noted that like reference numbers are used to depict the same or similar elements, features, and structures.

Hereinafter, the present disclosure is described with reference to the accompanying drawings. Various modifications are possible in various embodiments of the present disclosure and embodiments are illustrated in drawings and related detailed descriptions are described. However, the present disclosure is not limited to the specific embodiments, and it is understood that the present disclosure includes all modifications and/or equivalents and substitutes within the scope and technical range of the present disclosure.

In the present disclosure, the expressions “have”, “may have”, “include” and “comprise”, or “may include” and “may comprise” as used herein indicate the existence of corresponding features (e.g., elements such as numeric values, functions, operations, or components) but do not exclude the presence of additional features.

In the present disclosure, the expressions “A or B”, “at least one of A or/and B”, or “one or more of A or/and B”, and the like, as used herein may include any and all combinations of one or more of the associated listed items. For example, the terms “A or B”, “at least one of A and B”, or “at least one of A or B” may refer to all of the case (1) where at least one A is included, the case (2) where at least one B is included, or the case (3) where both of at least one A and at least one B are included.

Expressions such as “1st”, “2nd”, “first”, or “second”, and the like, as used in various embodiments of the present disclosure may refer to various elements irrespective of the order and/or priority of the corresponding elements, but do not limit the corresponding elements. The expressions may be used to distinguish one element from another element. For instance, both “a first user device” and “a second user device” indicate different user devices irrespective of the order and/or priority of the corresponding elements. For example, a first component may be referred to as a second component, and vice versa, without departing from the scope of the present disclosure.

It will be understood that when an element (e.g., a first element) is referred to as being “operatively or communicatively coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening elements (e.g., a third element).

Depending on the situation, the expression “configured to” as used herein may be used interchangeably with the expressions “suitable for”, “having the capacity to”, “designed to”, “adapted to”, “made to”, or “capable of”. The term “configured to” does not mean only “specifically designed to” in hardware. Instead, the expression “a device configured to” may mean that the device is “capable of” operating together with another device or other components. For example, a “processor configured to perform A, B, and C” may mean a general-purpose processor (e.g., a central processing unit (CPU) or an application processor) which may perform corresponding operations by executing one or more software programs which stores a dedicated processor (e.g., an embedded processor) for performing a corresponding operation.

Terms used in the present specification are used to describe specific embodiments of the present disclosure but do not limit the scope of the present disclosure. The terms of a singular form may include plural forms unless otherwise specified. Unless otherwise defined herein, all the terms used herein, which include technical or scientific terms, have the same meaning that is generally understood by a person skilled in the art. It will be further understood that terms, which are defined in a dictionary and commonly used, should also be interpreted as is customary in the relevant related art and not in an idealized or overly formal method unless expressly so defined herein. In some cases, even if terms are terms which are defined in the specification, they may not be interpreted to exclude embodiments of the present disclosure.

Hereinafter, a description will be provided of a method and an electronic device according to various embodiments with reference to the accompanying drawings.

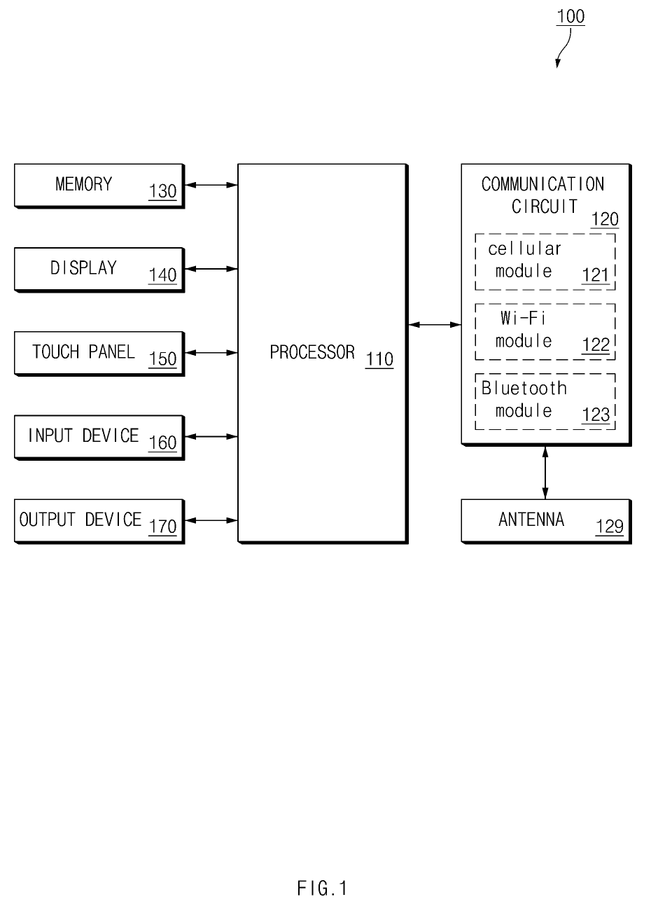

FIG. 1 is a block diagram of a mobile device, according to an embodiment of the present disclosure.

Referring to FIG. 1, a mobile device 100 includes a processor 110, a communication circuit 120, a memory 130, a display 140, a touch panel 150, an input device 160, and an output device 170. Some of the above-mentioned components may be omitted from the mobile device 100, or another component may be further included in the mobile device 100. For example, components such as a variety of sensors, a battery, or an input/output (I/O) interface may be further included in the mobile device 100.

The processor 110 may correspond to, for example, an application processor (AP) of the mobile device 100. In another example, the processor 110 may correspond to a central processing unit (CPU) or a processing core implemented in a system on chip (SoC) of the mobile device 100. The processor 110 may correspond to a processing circuit for controlling other components electrically connected to the processor 110 for performing functions in the mobile device 100.

The communication circuit 120 may correspond to, for example, a communication processor (CP) of the mobile device 100. In another example, the communication circuit 120 may correspond to a modem and/or a connectivity circuit implemented in an SoC of the mobile device 100.

The communication circuit 120 may include a variety of modules for supporting communication using various networks. For example, the communication circuit 120 includes a cellular module 121 for supporting cellular communication such as second generation/third generation (2G/3G), long term evolution (LTE), LTE-advanced (LTE-A), code division multiple access (CDMA), wideband CDMA (WCDMA), universal mobile telecommunications system (UMTS), and wireless broadband (WiBro). The communication circuit 120 includes a Wi-Fi module 122 for supporting Internet access via an access point (AP) such as Wi-Fi. The communication circuit 120 includes a Bluetooth module 123 for device-to-device communication.

The communication circuit 120 may further include additional modules. For example, the communication circuit 120 may have modules for near field communication (NFC) communication, Bluetooth low energy (BLE) communication, Wi-Fi direct communication, magnetic stripe transmission (MST) communication, or global positioning system (GPS) communication.

In an embodiment of the present disclosure, some communication modules may be implemented to be independent of the communication circuit 120. For example, a CP and a Wi-Fi module or a GPS module may be implemented with separate hardware or separate chips. In FIG. 1, it should be understood that the communication circuit 120 includes a module for communication in the mobile device 100. However, modules may not be located in one chip (e.g., an SoC) or one block corresponding to the communication circuit 120.

The communication circuit 120 may connect with an antenna 129. Each communication module (e.g., the cellular module 121, the Wi-Fi module 122, and the like) may connect with a radiator having an electrical length for transmitting/receiving a signal of a frequency band used by each communication module. Thus, the antenna 129 may include one or more radiators. The antenna 129 may include a front-end module (FEM), a filter, an amplifier, and the like associated with signal processing.

The communication circuit 120 may also include a module for wired communication.

The memory 130 may include a volatile and/or non-volatile memory. The memory 130 may store a command or data associated with a component of the mobile device 100. The memory 130 may software and/or a program. The program may include, for example, a kernel, a middleware, an application programming interface (API), and/or an application program (or “an application”), and the like. At least part of the kernel, the middleware, or the API may be referred to as an operating system (OS). The memory 130 may store data (e.g., a streaming application list and the like) associated with an embodiment of the present disclosure.

The display 140 may display a screen of an application. The display 140 may be implemented together with the touch panel 150 (e.g., a touch screen panel and the like). In this case, a user may generate a user input by touching the display 140. If the display 140 is implemented together with the touch panel 150, the display 140 performs functions of the input device 160 and the output device 170 together.

The touch panel 150 may be implemented as a touch key, a touch button, and the like at a front surface, a side surface, or a rear surface of the mobile device 100. For example, a variety of function keys, such as a home key and a back key located at a front surface of the mobile device 100, may be implemented on the touch panel 150. A touch panel may be used for implementing a touch screen and a touch panel used for implementing a function key may have a separate circuit or signal line.

The input device 160 may be implemented through additional physical buttons (e.g., a volume button, a power button, and the like) other than the touch screen or function key. The input device 160 may be a microphone for obtaining a voice input. The output device 170 may be a speaker, a vibrator, or a light emitting diode (LED).

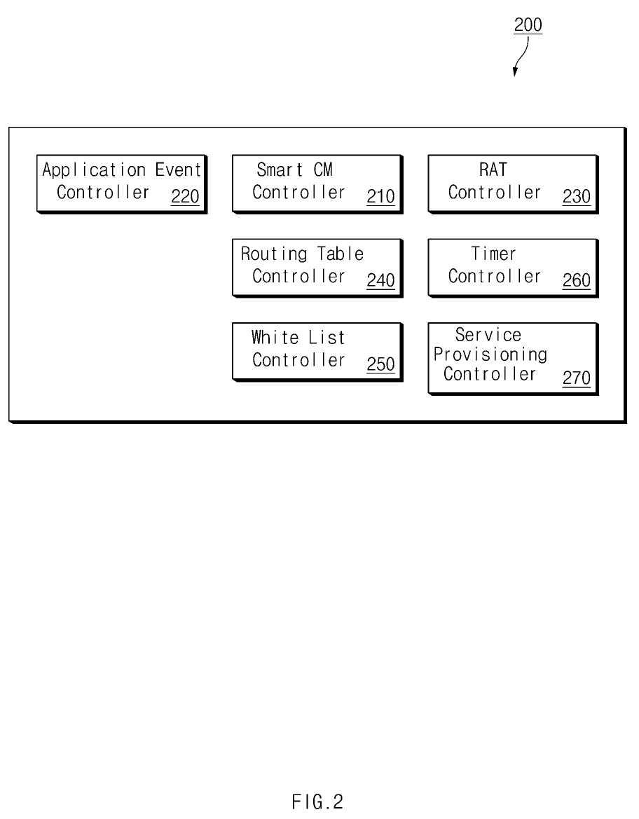

Hereinafter, a description of a smart connection management (CM) using the mobile device 100 will be provided with reference to FIGS. 2 to 8.

FIG. 2 is a block diagram illustrating a connectivity manager for smart connection management, according to an embodiment of the present disclosure.

Referring to FIG. 2, a connectivity manager 200 includes a smart CM controller 210, an application event controller 220, a radio access technology (RAT) controller 230, a routing table controller 240, a white list controller 250, a timer controller 260, and a service provisioning controller 270. The connectivity manager 200 or each of the modules 210 to 270 may be implemented as a command or program code stored in memory 130 of FIG. 1 and executed by processor 110 of FIG. 1. However, part of the connectivity manager 200 may be distributed and implemented as code executed by a communication circuit 120 of FIG. 1. Operations described as being performed by the connectivity manager 200 in the specification may be performed by the processor 110 or the communication circuit 120. Also, the modules 210 to 270 of the connectivity manager 200 may be classified according to a function performed by each of the modules 210 to 270. Two or more of the modules 210 to 270 may be integrated into one module, or one of the modules 210 to 270 may be divided into two or more modules.

If the communication circuit 120 downloads data (or content) from a server using two or more communication protocols, the connectivity manager 200 may adaptively determine a communication protocol to be used for downloading data based on a communication state of a network corresponding to each of the two or more communication protocols, a tariff applied to a mobile device 100 of FIG. 2, user settings, manufacturer settings, communication operator settings (or mobile network operator (MNO) settings), settings of an application, performance criteria (e.g., a download/upload bandwidth, a throughput, and the like) applied to the application, network selection criteria, and the like. In the present disclosure, a description will be provided of an embodiment of downloading data via the communication circuit 120. Herein, additionally or alternatively, if data is uploaded, the same processes or processes corresponding to those describing downloading may be applied. In the present disclosure, details described regarding downloading may be replaced with details regarding uploading or may be replaced with details regarding data or voice communication in general.

For example, if the communication circuit 120 includes a first communication module for communicating with a first network using a first communication protocol and a second communication module for communicating with a second network using a second communication protocol, the connectivity manager 200 may select/change a network to be used for downloading data based on information collected via the modules 210 to 270 of the connectivity manager 200. For example, the first communication module may be a cellular module 121 of FIG. 1 and may communicate with an LTE network using an LTE protocol. The second communication module may be a Wi-Fi module 122 of FIG. 1 and may communicate with a Wi-Fi network using an institute of electrical and electronics engineers (IEEE) 802.11 protocol. Each of the first network and the second network may be selected from a variety of communication protocols and is not limited to the above-mentioned examples. In the present disclosure, a description will be provided of embodiments with respect to the cellular network and the Wi-Fi network but the present disclosure is not limited to such.

The connectivity manager 200 may determine whether to use the cellular network or the Wi-Fi network when a download of data begins. Although data is being downloaded, the connectivity manager 200 may actively change a network to be used for a download to a network different from the network which is currently in use. In an embodiment of the present disclosure, operations performed by the connectivity manager 200 may be defined as a smart CM function.

The service provisioning controller 270 may determine whether a current environment is an environment which may use the smart CM function and may activate or deactivate the smart CM function. For example, if the smart CM function is applied to only a specific service, the service provisioning controller 270 may determine whether it is possible for the user of the mobile device 100 to use the corresponding service and may determine whether to use the smart CM function. For example, if a service provider (e.g., a communication operator (or an MNO) or a content provider) provides an unlimited streaming service and if the corresponding function is activated or deactivated by user settings, the service provisioning controller 270 may determine whether to activate or deactivate the corresponding function and may activate or deactivate the smart CM function for the unlimited streaming service. If the service provider provides a specific function to only certain subscribers, the service provisioning controller 270 may determine whether to use a corresponding service and may activate or deactivate the smart CM function. Corresponding information may be provided by the service provider. The service provisioning controller 270 may collect the corresponding information by various methods. For example, the service provisioning controller 270 may receive the corresponding information through communication with a service provider server or may obtain the corresponding information via an interface with a service provider application associated with a corresponding service.

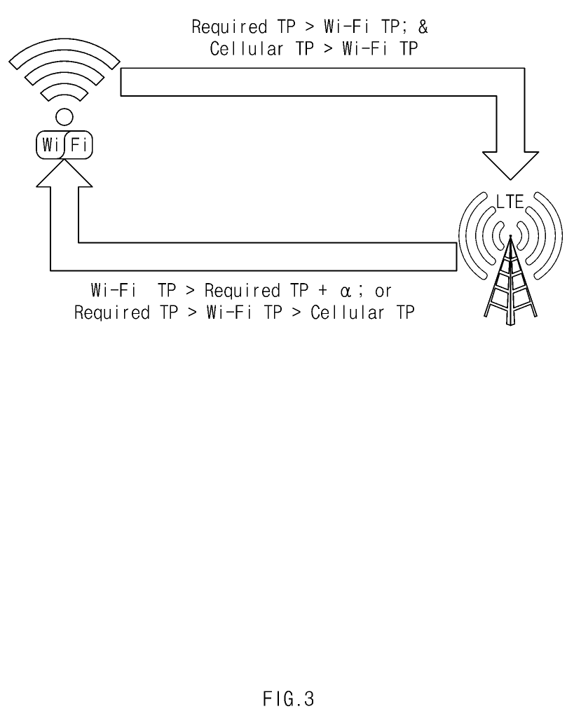

The smart CM controller 210 may analyze an event obtained via the application event controller 200 and may activate or deactivate the smart CM function based on the analyzed result. The smart CM controller 210 may include an enhanced network selection policy and a switching recovery algorithm. The smart CM controller 210 may prevent a continuous switching between the Wi-Fi network and the cellular network when both the Wi-Fi network and the cellular network are poor, based on the switching recovery algorithm. A description will be provided of the enhanced network selection algorithm with reference to FIG. 3.

The smart CM controller 210 may manage a Wi-Fi network throughput estimation value obtained from the Wi-Fi module 122 and a cellular network throughput estimation value obtained from the cellular module 121. The smart CM controller 210 may generate and manage a required throughput value based on a data rate which is in use by a currently executed application (e.g., a data rate required to maintain a service), obtained from the processor 110 (e.g., an AP). The smart CM controller 210 may store a required throughput value for each application and may determine a required throughput value to be used for smart CM in consideration of the throughput value and a current data rate.

Further, the smart CM controller 210 may select a network to be used for downloading data using the Wi-Fi/cellular network throughput estimation value based on the enhanced network selection algorithm. The smart CM controller 210 may provide the selected network information to the RAT controller 230.

The application event controller 220 may monitor and collect an event generated in a specified application via a framework (e.g., an Android framework). Herein, the specified application may have the smart CM function applied. For example, a streaming service application which provides streaming of video content such as a movie or a television (TV) program may correspond to the specified application. A list of the specified applications and the detailed function of the smart CM may be stored in the white list controller 250.

The application event controller 220 may collect, for example, a play event, a pause event, a resume event, and a stop event for content which is being executed by an application. The application event controller 220 may collect an input event by an input device 160 of FIG. 1 such as a home key or a back key, generated while the application is executed, and a foreground or background execution event of the application. In addition, the application event controller 220 may collect a user identifier (UID) or a process identifier (PID) and an event for executing and ending the application.

When the smart CM function is activated, if Wi-Fi is in an off state based on an instruction of the smart CM controller 210, the RAT controller 230 may change the Wi-Fi to an on state. The RAT controller 230 may update a network selected for the enhanced network selection algorithm via the smart CM controller 210 and may provide information about a network selected for changing a data traffic path to the routing table controller 240. The RAT controller 230 may store on/off state information of the Wi-Fi when the smart CM function is deactivated.

The routing table controller 240 may generate and manage a routing table for determining a routing path for data traffic of each of the applications activated in the foreground and the background. For example, the routing table controller 240 may provide information on a network to offload data traffic of a streaming service in which (additional) billing for data charges does not occur and information on a network to offload data traffic of another service, based on a tariff applied to the mobile device 100. For example, if a service provider provides an unlimited video streaming service to a Netflix application, if the corresponding application or service (e.g., the Netflix application or an unlimited streaming service) is registered in a white list, and if the user is a subscriber who may receive the corresponding service, the routing table controller 240 may define a routing table to offload data traffic of a video streaming service (e.g., an unlimited streaming service (USS)) onto the cellular network and offload data traffic of the other service onto the Wi-Fi. In another example, a routing table may be defined to offload both the data traffic of the video streaming service using the Netflix application and the data traffic of the other service onto the Wi-Fi. The routing table may include a UID value of an application (service). An example of entries in the routing table may be represented in Table 1 below.

TABLE 1

| Pre-defined Service | | | |
|---|---|---|---|
| Package Name | Service UID | USS Traffic Path | OS Traffic Path |
| com.android.netflix | 8890 | cellular | Wi-Fi |

The white list controller 250 may generate and manage a table including a pre-defined service application and a UID value. For example, the white list controller 250 may manage a white list such as Table 2 below.

TABLE 2

| Pre-defined Service Application | Android Process UID |
|---|---|
| ESPN | 1234 |
| HBO NOW | 2345 |
| Movieplex | 3456 |
| T-mobile TV | 4567 |
| . . . | . . . |

An application UID (e.g., an Android process UID) value may be updated via the application event controller 220. A white list managed by the white list controller 250 may be pre-defined, but may be changed by a tariff applied to the mobile device or a policy of a service provider or communication company and may be updated in real time. For example, a list of 12 applications may be included in a white list of the mobile device in which the user selects a tariff of $50 a month. However, if the tariff is changed to $100 a month, 12 applications (a total of 24 applications) are added to the white list. An application may be added or deleted based on a contract between a service provider, a communication operator (or an MNO) and a content provider. Information about the service addition/deletion may be updated in real time over a network. A service provided from a terminal manufacturer may be updated in real time via a server of the terminal manufacturer. A network may be considered a free network if there are no tariffs or data charges associated with downloading data using the network. A network may be considered a paid network if there are tariffs or data charges associated with downloading data using the network.

The timer controller 260 may define a smart CM timer. The timer controller 260 may determine a status of an application to which the smart CM function is applied. The status of the application may be defined by Table 3 below.

TABLE 3

| Value | Status |
|---|---|
| 0 | foreground |
| 1 | visible |
| 2 | perceptible |
| 3-7 | previous |
| 8~ | cached |

The term “visible” in Table 3 may refer to an application in a multi-window environment, such as a screen split, in which two applications are displayed on a display 140 of FIG. 1. In the case of an Android application, “perceptible” may correspond to an application which declares “persistent” in an AndroidManifest.xml file.

Referring to Table 3, if the status of the application does not correspond to value of “0”, the timer controller 260 may start a timer. If the status of the application corresponds to a value of “8” or more (or if the application is a cached application), the timer controller 200 may start the timer. If a plurality of applications to which the smart CM function is applied are executed, the timer controller 260 may start the timer if all the applications are not executed in the foreground. If an application to which the smart CM function is applied is stopped to obtain memory capacity, the timer may be stopped. If a time preset by the timer expires, the smart CM function may be deactivated. For example, if the user who uses a streaming service application changes the streaming service application to the background using a home key, a back key, and the like while viewing a video, the timer is started. If for example, the timer is set for 30 seconds and 30 seconds elapses, the smart CM function may be deactivated. However, if the streaming service application is changed to the foreground before the 30 seconds elapses, the timer may be initialized and stopped and the smart CM function may maintain an active state.

FIG. 3 illustrates an enhanced network selection algorithm, according to an embodiment of the present disclosure.

Referring to FIG. 3, a connectivity manager 200 (or a smart CM controller 210) of FIG. 2 may adaptively determine a first network or a second network for downloading of data. A description will be provided assuming that the first network is a Wi-Fi network and the second network is a cellular network.

In an embodiment of the present disclosure, an enhanced network selection algorithm may operate by the connectivity manager 200 having network control authority. For example, if a user selects a Wi-Fi network, and the Wi-Fi communication is in a poor state, a mobile device may perform data communication using the Wi-Fi. However, in a video or music streaming service, if the service is provided using the Wi-Fi network and the Wi-Fi network environment is poor, the user experience may be poor, for example, a video or music being played may repeatedly stop. Herein, although the user selects the Wi-Fi (or other relatively cheap network) to avoid or reduce data charges over the cellular network (or relatively expensive network), the enhanced network selection algorithm (or a smart CM function) may operate based on a tariff of the user. For example, the enhanced network selection algorithm may operate when the user uses an unlimited data plan or may operate so that extra charge does not occur when the user does not use the unlimited data plan.

In an embodiment of the present disclosure, when the data throughput (TP) required for an application is higher than the TP capability of a Wi-Fi network and the available cellular network provides a higher TP than the Wi-Fi network, the connectivity manager 200 may download data via the cellular network.

For example, a data TP of 2M bytes per second may be required to play a video currently served by an application. If it is predicted that a Wi-Fi TP is or will be reduced to 2 Mbps or less and if a cellular TP estimation value is greater than a Wi-Fi TP value, the connectivity manager 200 may switch from the Wi-Fi network to the cellular network and download data. Herein, the Wi-Fi TP may correspond to a current Wi-Fi TP, a cellular TP may correspond to an estimation value since a current state is not a state (e.g., a radio resource control (RRC) connected state) where the mobile device is connected to the cellular network. However, the mobile device may access the cellular network and may directly measure a data TP.

If several applications simultaneously use a data service, the connectivity manager 200 (or a communication circuit 120 of FIG. 1) may measure a data TP for each application and may operate a network selection algorithm for a specified application based on a data TP of an application to which the smart CM function is applied.

In an embodiment of the present disclosure, if a Wi-Fi network TP is higher than the required application TP by a constant value a or more, or if the required TP is higher than the Wi-Fi TP which is higher than the cellular TP, the connectivity manager 200 may download data via the Wi-Fi network.

In a state where data is downloaded using the cellular network, the connectivity manager 200 may continuously monitor a Wi-Fi TP from a Wi-Fi module 122. The mobile device may access a Wi-Fi access point (AP) and directly measure a TP. If it is determined that the Wi-Fi TP is higher than a required TP by a constant value a or more, the connectivity manager 200 may switch to a data download with the Wi-Fi network. In other words, although a communication state of the cellular network is good, the connectivity manager 200 may switch a connection to the Wi-Fi. Thus, a fee (or data limit) for a user may be reduced. If the user has unlimited data, he or she may not be affected. However, a large amount of traffic which congests the cellular network may be reduced through the switching to Wi-Fi operation, thus allowing many users to receive a seamless service.

The constant value a may be determined based on a switching recovery algorithm. If there is a very low probability that undesired network switching will occur or if the Wi-Fi TP is greater than the required TP when the switching recovery algorithm is not applied, the connectivity manager 200 may switch a connection from the cellular network to the Wi-Fi network. The constant value a may be set to a value determined by service quality. For example, if the user has an unlimited data service over the cellular network and if service quality from the cellular network is substantially the same as service quality from the Wi-Fi network, there is no advantage to the user if a connection is switched to the Wi-Fi network. If a better service quality is received over the Wi-Fi network, a higher resolution of the video service (ex. 720 pixels or 1280 pixels) may be provided over the Wi-Fi network as compared to the cellular network which may limit the video quality to a lower resolution of 480 pixels. The constant value a may determine the TP required for the higher resolution video service.

In addition to the above-mentioned condition, although the Wi-Fi TP is lower than a minimum data TP (or the required TP) necessary for providing a service, if a TP of the Wi-Fi network is higher than a TP of the cellular network, the connectivity manager 200 may switch a connection from the cellular network to the Wi-Fi network.

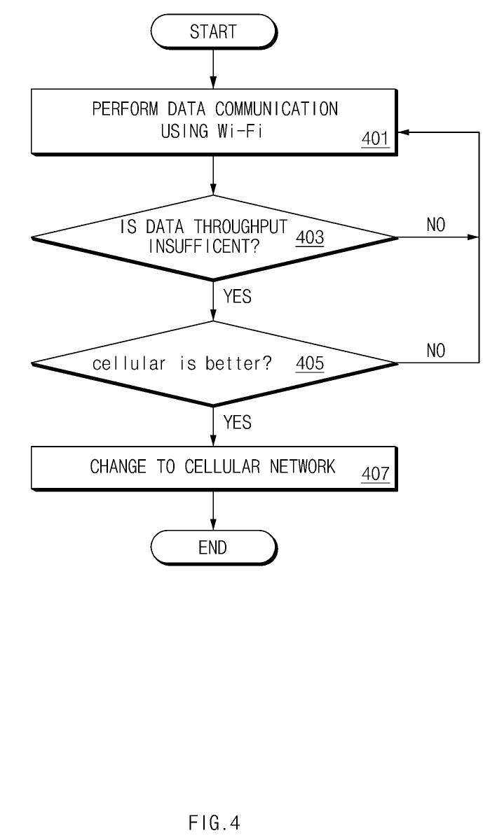

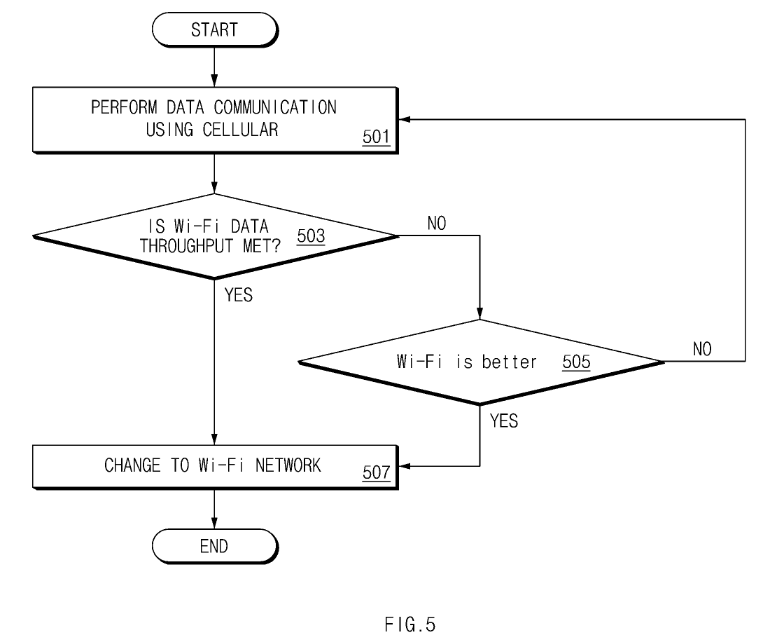

Hereinafter, a description of operations performed in the mobile device based on the enhanced network selection algorithm will be provided with reference to FIGS. 4 and 5.

FIG. 4 is a flowchart illustrating an operation of switching a connection from a Wi-Fi network to a cellular network, according to an embodiment of the present disclosure.

Referring to FIG. 4, in operation 401, a mobile device performs data communication using a Wi-Fi network. For example, the mobile device may receive data over the Wi-Fi network from a server using a Wi-Fi module 122.

In operation 403, the mobile device determines whether a data throughput of the Wi-Fi network is currently insufficient compared with a data throughput required for receiving the data. If the data throughput of the Wi-Fi network is sufficient, the mobile device may continue receiving data using the Wi-Fi network.

If it is determined that the data throughput of the Wi-Fi network is insufficient, in operation 405, the mobile device determines whether a communication state of a cellular network is better than that of the Wi-Fi network. If the communication state of the cellular network is not better than that of the Wi-Fi network, the mobile device continues receiving data using the Wi-Fi network.

If the communication state of the cellular network is better than that of the Wi-Fi network, the mobile device changes a network used for receiving data to the cellular network in operation 407.

FIG. 5 is a flowchart illustrating an operation of switching a connection from a cellular network to a Wi-Fi network, according to an embodiment of the present disclosure.

Referring to FIG. 5, in operation 501, a mobile device performs data communication using a cellular network. For example, the mobile device 100 may receive data over the cellular network from a server using a cellular module 121.

In operation 503, the mobile device determines whether a data throughput of a Wi-Fi network meets a data throughput required for receiving the data. If the Wi-Fi network meets the data throughput required for receiving the data, in operation 507, the mobile device may receive data using the Wi-Fi network.

If a data throughput of the Wi-Fi network does not meet the data throughput required for receiving the data, in operation 505, the mobile device determines whether a communication state of the Wi-Fi network is better than that of the cellular network. If the communication state of the Wi-Fi network is better than that of the cellular network, in operation 507, the mobile device receives data using the Wi-Fi network. If the communication state of the Wi-Fi network is not better than that of the cellular network, the mobile device may continue receiving data over the cellular network.

In the description with reference to FIGS. 3 to 5, the Wi-Fi network and the cellular network may correspond to a first network and a second network. Alternatively, the Wi-Fi network and the cellular network may correspond to an inexpensive network and an expensive network, a free network and a paid network, and the like.

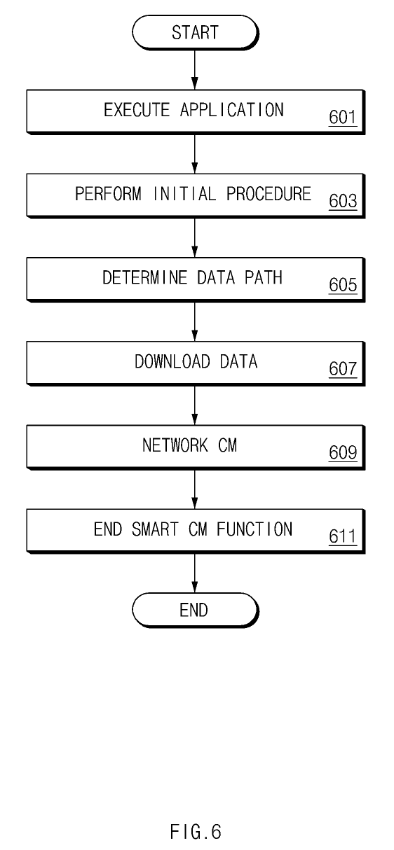

Hereinafter, a description of operations of the mobile device to which a smart CM function is applied will be provided with reference to FIGS. 6 to 9.

FIG. 6 is a flowchart illustrating a smart CM process, according to an embodiment of the present disclosure.

Referring to FIG. 6, in operation 601, a processor executes an application. A plurality of applications may be stored in a memory 130. If a specified application (e.g., a streaming service application) among the plurality of applications is executed, a smart CM process may be applied. For example, if browsing or a content downloading application (or service) is executed, a routing path may be established to a Wi-Fi network. In case of a voice call, a routing path may be established to a cellular network for stability of the voice call. For example, applications corresponding to a white list managed by a white list controller 250 among the plurality of applications may be applied to a smart CM function, but the other applications may be set by a user, or only a network required by an application may be used. Hereinafter, assuming that an application to which the smart CM function is applied is executed, a description will be provided of a process described in the flowchart of FIG. 6.

In FIG. 6, operations starting at operation 603 may correspond to operations according to activation of the smart CM function. The smart CM function may be activated, for example, when a condition where the smart CM function may operate is met. For example, the smart CM function may be activated by a condition such as a tariff of a user (or whether the user is charged) and whether a pre-defined service is activated. The smart CM function may be activated as soon as the application of operation 601 is executed (i.e., in response to the execution of the pre-defined application). As another example, after an application is executed, the smart CM function may be activated at a time when the playing of content (e.g., a movie, music, a television (TV) program, and the like) is started. As another example, after an application is executed and content is playing, the smart CM function may be activated at a time when data traffic for content substantially occurs (e.g., at a time when a streaming server is requested to transmit content to be played and when a data download is started from the streaming server). A description will be provided assuming that the smart CM function is executed as soon as an application is executed. In other words, the processor may perform operation 603 as soon as recognizing that operation 601 is performed.

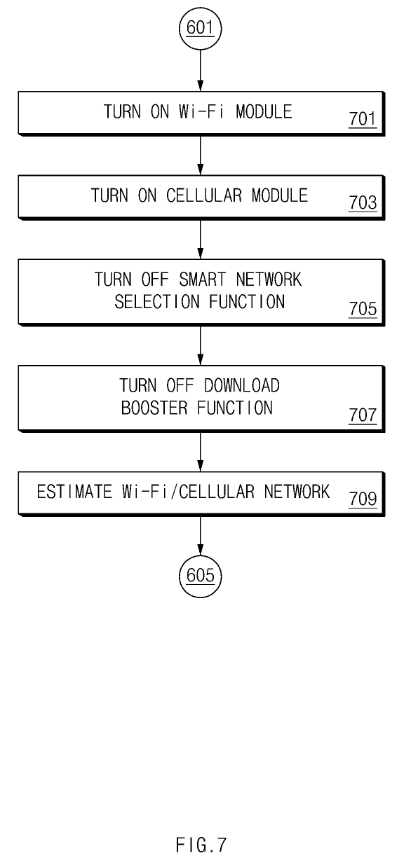

In operation 603, the processor performs an initial procedure. The initial procedure may correspond to a procedure of determining whether to start downloading data using any network. For example, if operations 601 and 603 are performed in a state where the user manually sets a Wi-Fi network and if it is determined that a sufficient bandwidth is not obtained over the Wi-Fi as a result of performing operations 601 and 603, the processor may determine to start downloading data over a cellular network. A description will be provided of a detailed process of the initial procedure with reference to FIG. 7.

In operation 605, the processor determines a data path based on the result of performing the initial procedure. For example, if the Wi-Fi network meets a throughput required for providing a service as a result of performing the initial procedure, the processor may determine to download data using the Wi-Fi network. If the Wi-Fi network does not meet the throughput required for providing the service as a result of performing the initial procedure and if a cellular network service is relatively good, the processor may determine to download data using the cellular network. In addition, the processor may determine a network to download data, based on a tariff applied to a mobile device. For example, in each of a case where the user subscribes to a tariff, in which there is no limit to data usage and which is available for a specific streaming service, for $100 a month, a case where he or she subscribes to a tariff, in which data usage is limited to 10 GB and which is available for the specific streaming service, for $70 a month, and a case where he or she subscribes to a tariff unavailable for the specific streaming service, a data traffic path may be determined in a different way by the processor.

In an embodiment of the present disclosure, considering the tariff may be performed at a time when the application is executed or before the application is executed. For example, an application added to a while list may be set in a different way based on a tariff Also, a setting value of an application added to the white list may be determined in a different way based on a tariff. For example, if a tariff for unlimited data is used, a streaming service application may be configured to provide content of relatively high image quality (e.g., 720 pixels or high definition (HD) image quality). If a general tariff for data (in which data usage is limited to 10 GB) is used, the streaming service application may be configured to provide content of relatively low image quality (e.g., 480 pixels). A minimum data throughput required for a content service may be changed based on each case. Thus, although each network state is determined based on the performance of the initial procedure, a selected data path may be changed based on a tariff to which the user subscribes.

In operation 607, the processor allows a communication circuit to download data (e.g., video data, a caption file, and the like) associated with the streaming service application using a selected network.

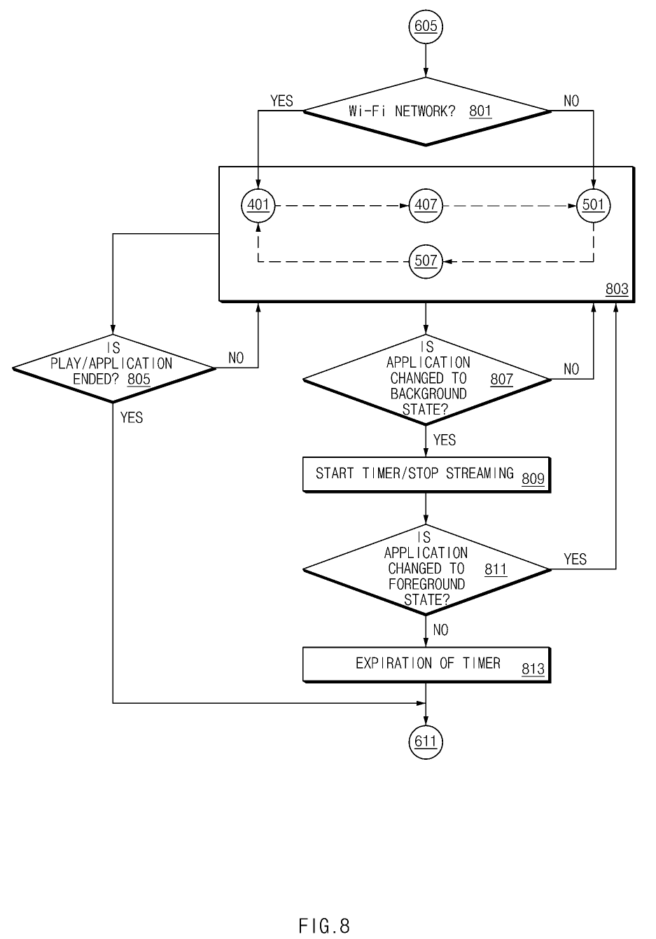

While the data is downloaded, the processor may perform network CM. In other words, operation 609 may be performed continuously or periodically while operation 607 is performed, rather than being performed after operation 607 is completed. The network CM may include network state monitoring for a connected first network (e.g., the Wi-Fi) and a second network (e.g., the cellular) which is not connected, network connection change according to a monitored result, and an operation of determining a state where an application is executed. In this regard, a description will be provided in detail with reference to FIG. 8.

If an end condition is met, in operation 611, the processor ends a smart CM function. For example, if the play of content has ended, if an application has ended, or if an event such as the expiration of a timer after an application has changed to the background, the processor may determine that an end condition of the smart CM function is met. In this case, the processor may end the smart CM function. In other words, the processor may turn off a network monitoring function and a network selection function. Also, in operation 611, if the end condition is met, the processor may end the smart CM function. For example, the end condition may correspond to if there is a change in providing a corresponding service due to a change of a tariff of the user or if a policy of a communication operator (or an MNO) or a service provider has changed, or the user manually deactivates the smart CM function.

If the smart CM function has ended, the mobile device may restore network settings to a state before the smart CM function is activated. For example, if the mobile device is connected to the Wi-Fi network before the smart CM function is activated (e.g., before a streaming application is executed), although the mobile device connects to the cellular network and plays content, if the smart CM function has ended (e.g., if the playing of the content is ended), the mobile device may restore the connection to the Wi-Fi network, and vice versa.

FIG. 7 is a flowchart illustrating an initial procedure, according to an embodiment of the present disclosure.

An initial procedure shown in FIG. 7 may be an example for selecting a preferred wireless resource among wireless resources which are currently available to a mobile device. In FIG. 7, a description will be provided assuming that Wi-Fi is used as a first network and cellular is used as a second network (or vice versa) and that the mobile device supports a smart network selection function and a download booster function.

Operation 701 may be performed after operation 601, that is, after a pre-defined application is executed. For example, an application event controller may verify an event which occurs based on execution of the application. If an event corresponding to a specified service is generated, the application event controller may start operation 701.

In operation 701, a processor activates a Wi-Fi module. If the Wi-Fi module is already activated, operation 701 may be omitted. After performing operation 701, the processor may scan an access point (AP).

In operation 703, the processor activates a cellular module. If the cellular module is already activated, operation 703 may be omitted. After performing operation 703, the processor may scan a network.

In operation 705, the processor deactivates the smart network selection function. Herein, the smart network selection function may correspond to a function of automatically activating the cellular network and deactivating the Wi-Fi network (or vice versa) if a Wi-Fi signal is reduced to a threshold value or less although a user manually activated the Wi-Fi network. If the function is already deactivated or in case of a terminal which does not support this function, operation 705 may be omitted.

In operation 707, the processor deactivated the download booster function. If the download booster function is activated, for example, the mobile device may activate all diversity antennas while increasing battery consumption, thus optimizing download performance. However, since a value different from the actual network state may be measured if the download booster function is activated when estimating a network state in operation 709, the processor may deactivate the download booster function. If there is no download booster function or if the download booster function is already deactivated, operation 707 may be omitted.

In operation 709, the processor estimates a network state using the Wi-Fi module and the cellular module. For example, the processor may download dummy data over the Wi-Fi network or may measure or estimate a data throughput in each network through a received signal strength indicator (RSSI) value of an antenna. For example, the processor may determine a throughput estimated when using the Wi-Fi network and a throughput estimated when using the cellular network. The estimated result may be used for determining an initial data path in operation 605.

In an embodiment of the present disclosure, the process described in the flowchart of FIG. 7 may be completed before a download of content is started. However, if it takes a long time to scan a network in a weak network area, the process of FIG. 7 may fail to be completed before a content download is started. In the former case, the processor may receive content through an initial data path determined by the process of FIG. 7. In the latter case, the processor may receive content by using a data path set before the process of FIG. 7 as an initial data path. For example, although both the Wi-Fi and the cellular modules are turned on to perform the process of FIG. 7 in a state where the Wi-Fi is turned on and the cellular is turned off, if the performance of operation 709 is not completed before a content download is started, the mobile device may start to download data through the Wi-Fi network. In this case, after the download is started, the mobile device may change a network for receiving data based on the result of performing operation 709 or may immediately enter a process of FIG. 8.

FIG. 8 is a flowchart illustrating a network CM process, according to an embodiment of the present disclosure.

The network CM of FIG. 8 is performed after an operation (operation 605) of determining an initial data path is performed. As described above, the initial data path may be established by operation 709 and may be established before the process of FIG. 7 has completed. A process of FIG. 8 may be continuously performed while content is downloaded.

In operation 801, a processor determines whether an initial path of a data download is a Wi-Fi network or a cellular network.

The processor starts operation 803 based on the result determined in operation 801. Operation 803 may correspond to an operation of repeatedly performing processes shown in FIGS. 4 and 5. For example, if the initial path is the Wi-Fi network, the processor may perform operation 401 in the process shown in FIG. 4. The processor may continue downloading data using the Wi-Fi in operation 401 based on the process of FIG. 4 or may change a network to download data through operations 403 and 405 to the cellular network in operation 407.

If changing the network to download data from the cellular network or if the initial data path is the cellular network, the processor may perform operation 501 in the process shown in FIG. 5. The processor may continue downloading data using the cellular network based on the process of FIG. 5 or may change a network to download data through operations 503 and 505 from the Wi-Fi network in operation 507.

The cyclic process of operation 803 may be continuously performed until an end condition described below occurs.

In operation 805, the processor determines whether the playing of content using an application has ended or whether the application has ended. If the playing of the content or the application has ended, the processor ends a smart CM function in operation 611.

In operation 807, the processor determines whether an application is changed from a foreground state to a background state, for example, since an input of a home key or a back button of a user occurs. If the application has changed to the background state, in operation 809, the processor may change the smart CM function to an idle mode. The processor may define the smart CM function as entering the idle mode based on one or a combination of cases where the application has changed to the background state, a case where the application changes a foreground position in a state where it has not ended, and a case where streaming data traffic does not occur. The idle mode of the smart CM function may be defined as the processor stops data streaming and starts a timer. For example, the timer may be started by a timer controller of a connectivity manager.

In operation 811, the processor determines whether the application has changed to the foreground state. The processor may determine whether a condition corresponding to the idle mode of the smart CM function is released. Since a data download has started again or will be started if the application is changed to the foreground state, the processor may release the idle mode of the smart CM function and perform operation 803.

In operation 813, if a pre-defined timer expires in a state where the smart CM function enters the idle mode, the processor may end the smart CM function in operation 611.

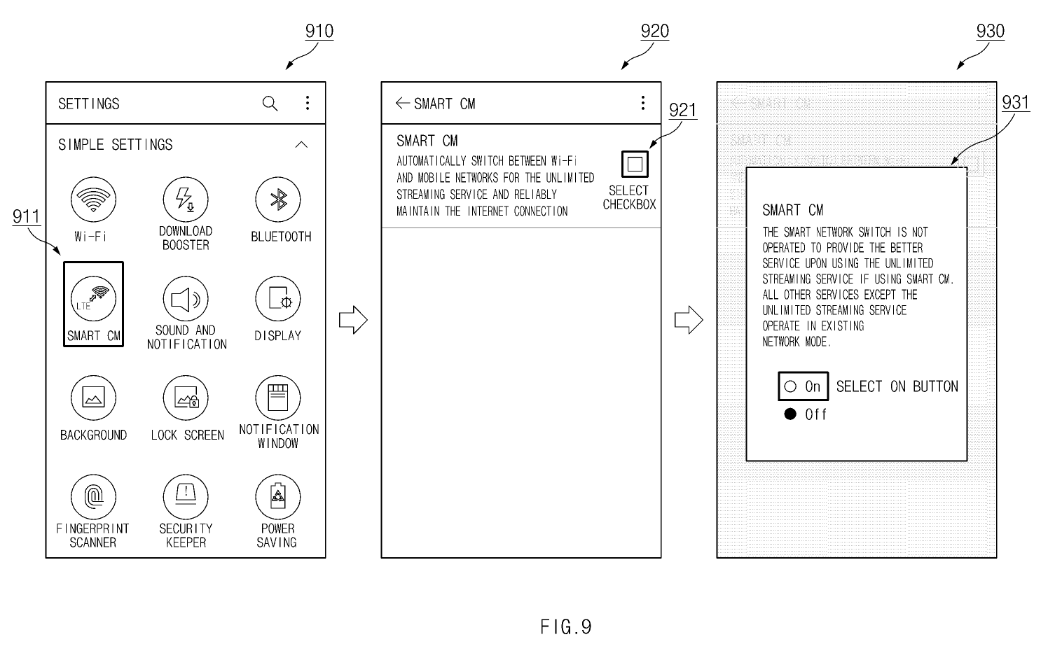

FIG. 9 illustrates a user interface (UI) for setting smart CM, according to an embodiment of the present disclosure.

Referring to FIG. 9, a setting screen 910 is displayed on a display. If a smart CM item 911 is selected by a user, the display provides a checkbox 921 to choose whether to use the smart CM function. In FIG. 9, the checkbox 921 for using smart CM with respect to an unlimited streaming service may be provided, but a variety of items may be additionally provided based on a tariff of the user. For example, a data limit of 10 GB may be assigned to the user every month. An item of applying smart CM in both directions (e.g., Wi-Fi⇄cellular) until data usage reaches a certain limit (e.g., 70%) and applying only smart CM in a single direction (e.g., cellular→Wi-Fi) if data usage is below a certain limit (e.g., if data usage of less than 30% remains) may be provided. In addition, an item about whether smart CM will be applied to only an unlimited streaming service or other applications (e.g., an Internet application, a game application, and the like) may be provided.

If the checkbox 921 is selected, the display may display a guide message screen 930. For example, a message 931 including a description for the selected item and an on/off button may be provided.

The screen shown in FIG. 9 is an example, and a variety of guide screens may be provided based on implementation.

In an embodiment of the present disclosure, a pop-up message may be provided rather than a separate setting menu or in addition to a separate menu. For example, if an application (e.g., an application registered with a white list) to which the smart CM function is applied is executed, a processor may display a proper pop-up message on the display 140. For example, a message indicating that a Wi-Fi network and a cellular network may be adaptively used based on a communication environment may be displayed when content provided by an application is downloaded. The message may include a menu for approving or denying the application of the smart CM function. The pop-up message may include information on a tariff to which the user currently subscribes and information about a remaining data usage limit.

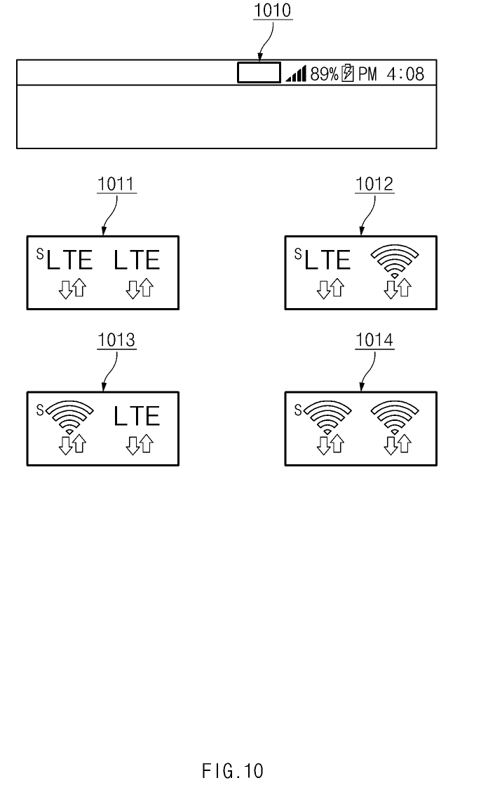

FIG. 10 illustrates a UI for selecting smart CM, according to an embodiment of the present disclosure.

Referring to FIG. 10, if a smart CM function is activated, both an icon indicating a network used by a service to which the smart CM function is applied and an icon indicating a network used by another service may be displayed on a region 1010 of a notification bar. In this case, an icon indicating signal strength of each network may be displayed.

If the smart CM function is applied to an unlimited streaming service (USS) and is not applied to the other service, an icon indicating a network to which the smart CM function is applied may be displayed differently from an icon indicating a network to which the smart CM function is not applied. If both the USS and the other service use a cellular network (e.g., LTE), icon 1011 may be displayed on the region 1010. If the USS uses the cellular network and the other service uses Wi-Fi, icon 1012 may be displayed on the region 1010. If the USS uses the Wi-Fi network and the other service uses the cellular network, icon 1013 may be displayed on the region 1010. If both the USS and the other service use the Wi-Fi network, icon 1014 may be displayed on the region 1010.

According to an embodiment of the present disclosure, at least part of a device (e.g., modules or functions) or a method (e.g., operations) may be implemented with, for example, program instructions stored in a non-transitory computer-readable storage media. When the program instructions are executed by one or more processors (e.g., a processor of FIG. 1), the one or more processors may perform functions corresponding to the program instructions. The non-transitory computer-readable storage media may be, for example, a memory 130 of FIG. 1.

Further, program instructions may include not only mechanical codes compiled by a compiler but also high-level language codes which may be executed by a computer using an interpreter and the like. The above-mentioned hardware device may be configured to operate as one or more software modules to perform operations according to various embodiments of the present disclosure, and vice versa.

According to an embodiment of the present disclosure, the mobile device may maintain optimal performance based on network states when a user consumes content.

Further, the user may consume content based on a tariff to which he or she subscribes, and the communication operator or the MNO may manage congested data traffic on a network.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A mobile device, comprising:
a memory configured to store a plurality of applications;
a communication circuit including a first communication module and a second communication module, the first communication module being connected to a first network using a first communication protocol and the second communication module being connected to a second network using a second communication protocol; and
a processor electrically connected with the communication circuit,
wherein the processor is configured to:
execute a streaming service application among the plurality of applications,
select one of the first network and the second network based on the communication state of the first network, the communication state of the second network and a tariff applied to the mobile device, and
download content associated with the streaming service application from a streaming server using the selected network.

2. The mobile device of claim 1, wherein the processor is further configured to:
determine whether a communication state of the selected network meets a data throughput required for downloading the content, and
download the content from the streaming server over a network different from the selected network based on the communication state of the first network and the communication state of the second network, when the communication state of the selected network does not meet the required data throughput.

3. The mobile device of claim 1, wherein the processor is further configured to:
when a voice call application among the plurality of applications is executed, receive data corresponding to the voice call application over a pre-defined network among the first network and the second network.

4. The mobile device of claim 1, wherein the memory stores a list of one or more applications, and
wherein the processor is further configured to:
receive data corresponding to an application which is not included in the list, over a pre-defined network among the first network and the second network.

5. The mobile device of claim 1, wherein the processor is further configured to:
monitor the communication state of the first network and the communication state of the second network, while the streaming service application is executed.

6. The mobile device of claim 5, wherein the processor is further configured to:
stop the monitoring of the communication state of the first network and the communication state of the second network, when the streaming service application has ended.

7. The mobile device of claim 5, wherein the processor is further configured to:
start a timer, when the streaming service application is executed in a background state, and
end the timer, when the streaming application is executed in a foreground state.

8. The mobile device of claim 7, wherein the processor is further configured to:
stop the monitoring, when a time specified by the timer elapses.

9. The mobile device of claim 1, wherein the processor is further configured to:
display a message on a display indicating that the first network and the second network are adaptively used to download the content, when the streaming service application is executed.

10. A network connection management method of a mobile device, the method comprising:
executing a streaming service application;
selecting one of a first network and a second network based on a communication state of the first network, a communication state of the second network and a tariff applied to the mobile device; and
downloading content associated with the streaming service application from a streaming server using the selected network.

11. The method of claim 10, further comprising:
when the selected network is a free network, downloading the content over a paid network based on a data throughput of the free network, a data throughput required for playing the downloaded content, and a data throughput of the paid network.

12. The method of claim 10, further comprising:
when the selected network is a paid network, if a free network meets a data throughput required for playing the content, downloading the content over the free network.

13. The method of claim 10, further comprising:
starting a timer, when the streaming service application is executed in a background state; and
ending the timer, when the streaming application is executed in a foreground state.

14. The method of claim 13, further comprising:
restoring network settings to a state before the streaming service application is executed, when the timer expires.

15. A mobile device, comprising:
a memory configured to store a plurality of applications;
a communication circuit including a first communication module and a second communication module, the first communication module being connected to a first network using a first communication protocol and the second communication module being connected to a second network using a second communication protocol; and
a processor electrically connected with the communication circuit,
wherein the processor is configured to:
execute an application among the plurality of applications,
select one of the first network and the second network based on a communication state of the first network, a communication state of the second network, a tariff applied to the mobile device, a service policy applied to the application, a performance criteria applied to the application, and a network selection criteria, and
download data from a server associated with the application using the selected network.

16. The mobile device of claim 15, wherein one of the first network and the second network corresponds to a cellular network and the other of the first network and the second network corresponds to a wireless-fidelity (Wi-Fi) network.

17. The mobile device of claim 15, wherein one of the first network and the second network corresponds to a paid network and the other of the first network and the second network corresponds to a free network.

18. The mobile device of claim 16, wherein the processor is further configured to:
determine whether a communication state of the cellular network meets a data throughput required for downloading the data, and
when the communication state of the cellular network does not meet the required data throughput, if a communication state of the Wi-Fi network is better than the communication state of the cellular network, download the data over the Wi-Fi network.

19. The mobile device of claim 16, wherein the processor is further configured to:
determine whether a communication state of the Wi-Fi network meets a data throughput required for downloading the data, and
when the communication state of the Wi-Fi network meets the required data throughput, download the data over the Wi-Fi network.

20. The mobile device of claim 19, wherein the processor is further configured to:
when the communication state of the Wi-Fi network does not meet the required data throughput, if the communication state of the Wi-Fi network is better than a communication state of the cellular network, download the data over the Wi-Fi network.
